(19) United States
(12) Patent Application Publication
(10) Pub. No.: US 2012/0297947 A1
(43) Pub. Date: Nov. 29, 2012

(54) Device for the Automated Slicing of Bread, Having Improved Blade-Supporting Frames

(76) Inventor: Baudouin Van Cauwenberghe, Beersel (BE)

(21) Appl. No.: 13/576,991

(22) PCT Filed: Feb. 8, 2010
(86) PCT No.: PCT/EP10/00766

§ 371 Date: Aug. 3, 2012

(51) Int. Cl. B26D 1/11; B26D 7/26

(52) U.S. Cl. 83/167

(57) ABSTRACT

A device for the automated slicing of bread, including a first assembly of bread cutting blades and one supporting frame for said blade assembly, each frame having a substantially rectangular shape and including two longitudinal members arranged substantially parallel to each other and two transverse members arranged substantially parallel to each other and substantially perpendicular to the two longitudinal elements. Each frame consists of two substantially rectangular single-piece rigid elements assembled together, each rigid element including a portion of each longitudinal member and of each transverse member of the frame having a shape complementary to a corresponding portion of the other rigid element of said frame and being arranged so that said rigid elements impart a three-dimensional structure for said frame together. The frame has a rectangular shape, does not include cohesion irregularities between the members, and is therefore more stable and less subject to deformation.

The present invention relates to a device for the automatic slicing of bread.

### BACKGROUND OF THE INVENTION

Devices for the automatic slicing of bread are well known. They are present in most of the artisanal bakeries as well as in supermarkets. These devices, or automatic slicing machines, run according to the following principle: The user of the device introduces therein the bread he wants to be sliced, places it in the loading compartment of the device and once the bread is sliced, he takes said bread in a discharging compartment of the latter. At least a first set of bread slicing blades and at least a first supporting frame of said set of slicing blades are arranged between said loading compartment and said discharging compartment of bread, each supporting frame having a substantially rectangular shape and comprising two longitudinal members arranged substantially in parallel to each other and two transversal members arranged substantially in parallel to each other and substantially orthogonally to said two longitudinal members, the blades of a set of blades being connected by each of their extremities to a longitudinal member of a supporting frame, by a connecting means and being arranged substantially in parallel to each other and to the transversal members of said frame. Once bread is introduced into the loading compartment, the user of the device starts it by switching on the switch arranged therefore, this leading to an oscillating movement of each supporting frame of a set of blades and to a translation movement of a bread pusher, transversally to the direction of the blades and towards these blades. The bread is consequently moved by the pusher to the blades and the slicing starts when it touches said blades. The user takes his sliced bread out of the discharging compartment on the side of the blades which is opposed to the one where the loading compartment of bread in the device is located. The user has then just to wrap the sliced bread.

In practice, two set of blades are present in the device, each of said set being held by a different supporting frame and arranged outside its supporting frame, substantially in parallel to the latter, these supporting frames being arranged in parallel to each other in the device, the two sets of blades facing each other in such a way that each blade of the first set of blades is located alternately with a blade of the second set of blades, the cutting edge of each blade of the first set of blades being oriented in opposite direction to the orientation of the cutting edge of each blade of the second set of blades with regard to their respective supporting frame, so that the cutting edges of all the blades are oriented towards the loading compartment for loading breads into the device. During the slicing of bread, the two supporting frames are moved in opposite directions in order to ensure an optimal bread slicing quality. Therefore, a motor as well as a conversion means for converting the movement of this motor into an oscillating movement of each supporting frame of a set of blades are arranged in the device, such a means being well known by the skilled person.

In a device according to the prior art, each supporting frame of a set of blades consists in four individual distinct rent profiles, the profiles forming the two transversal members of the frame having generally a “U” shaped section and the profiles forming the two longitudinal members of the frame having generally a “O” shaped section, the transversal profiles being assembled to the longitudinal profiles at their respective extremities, usually by welding.

Such an assembly suffers from several drawbacks. Firstly, it often happens that due to a position defect of the four individual distinct profiles during their assembling to each other by welding, the frame they are part of after welding is not correctly rectangular, which during the operation of the device, causes imbalances of the moving masses of each frame and consequently important vibrations in the device. Secondly, it is in practice impossible that all the weld seams that assemble two of the four profiles forming a supporting frame are realized with the same cohesion between the two assembled elements. Though, the blades of the set of blades that the frame must support are each tensed between the two longitudinal members of this frame with a strength of several hundreds of Newtons so that for a whole set of blades this may result in the equivalent of a charge of several tons on the frame. Therefore, a cohesion difference between the assembled profiles of the frame may under the action of this charge lead to a weakening of this frame and consequently to a deformation of the latter. This happens all the more when the set of blades held by a frame is located outside the latter and that consequently, the tension strength applied by the set of blades on the frame is not homogeneously spread inside the frame but on the contrary tends to bend it orthogonally to said set of blades. Such a deformation would be moreover increased if, as mentioned above, the frame is not perfectly rectangular due to a position defect of the four individual distinct profiles which constitute said frame, during their assembling to each other by welding.

### SUMMARY OF THE INVENTION

The present invention overcomes the above listed drawbacks by providing a device for the automatic slicing of bread comprising a mount, a loading compartment for loading bread to be sliced, a discharging compartment for discharging a sliced bread, at least a first set of slicing blades and at least a first supporting frame of said set of blades, arranged between said loading compartment and said discharging compartment, each supporting frame having a substantially rectangular shape and comprising two longitudinal members arranged substantially in parallel to each other and two transversal members arranged substantially in parallel to each other and substantially orthogonally to said two longitudinal members, the blades of a set of blades being connected by each of their extremities to a longitudinal member of a supporting frame by a connecting means and being arranged substantially in parallel to each other and to the transversal members of said frame, each frame consisting in a first and a second substantially rectangular monolithic rigid elements assembled to each other, each said rigid element comprising a portion of each longitudinal member and of each transversal member of the frame, each of said portions having a shape which is complementary to the shape of a corresponding portion of the other rigid element of said frame and each of said rigid elements being arranged so that said rigid elements together provide said frame with a tridimensional structure.

Thanks to the fact that each supporting frame of the device consists in a first and a second substantially rectangular monolithic rigid elements assembled to each other, each comprising a portion of each longitudinal member and of each transversal member of the frame, said portions having each a shape which is complementary to the shape of a corresponding portion of the other rigid element of said frame and thanks to the fact that these two rigid elements are arranged for together providing said frame with a tridimensional structure, this frame does not consists in four individual distinct profiles assembled to each other as according to the prior art and therefore, the drawbacks due to this specific configuration are overcome, i.e. the frame according to the invention is correctly rectangular and no cohesion differences between the transversal and the longitudinal members of the frame does occur since each rigid monolithic element comprises a portion of each transversal member and of each longitudinal member of the frame. This frame is thus provided with a better rigidity and a better stability under the tension applied by the set of tensed blades said frame does support.

### BRIEF DESCRIPTION OF THE DRAWINGS

The invention will now be described in greater details through an example of embodiment which does not limit the scope of the claims, illustrated by the enclosed figures, in which:

FIG. 1 is a schematic view in partial vertical profile cut of a device according to the invention.

FIG. 2a is a perspective view of the two rigid elements of a supporting frame of a set of blades of the device shown in FIG. 1, positioned face to face and not assembled to each other and FIG. 2b is a same view of these two elements assembled to each other in order to constitute said frame.

FIG. 2c is a perspective view of the frame shown in FIG. 2b to which is connected a set of blades by a connecting means.

FIG. 3a is a profile view of the two rigid elements shown in FIG. 2a and FIG. 3b is a profile view of these two elements assembled to each other in order to constitute said frame.

In the figures, the same reference numbers designate the same elements of the device according to the invention.

### DETAILED DESCRIPTION OF THE INVENTION

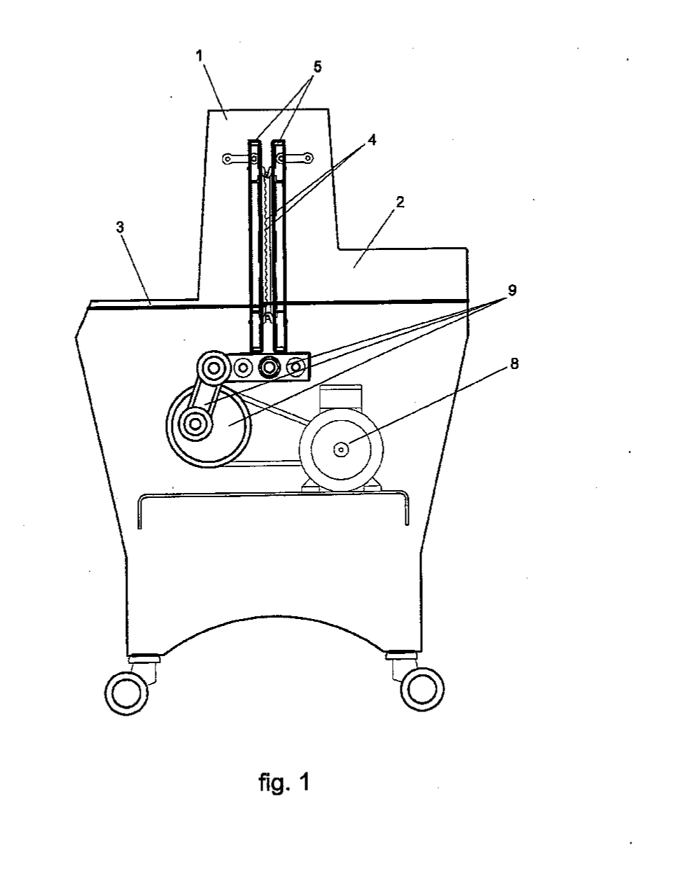

FIG. 1 shows a device for the automatic slicing of bread according to the invention comprising a mount 1, a loading compartment 2 for loading bread to be sliced, a discharging compartment 3 for discharging a sliced bread, a first and a second set 4 of slicing blades and a first and a second supporting frame 5 respectively of said first and of said second set of blades, arranged between said loading compartment and said discharging compartment of bread. Each set of blades is arranged outside its supporting frame, substantially in parallel to the latter, these supporting frames being arranged in parallel to each other in the device, the two set of blades facing each other in such a way that each blade of the first set of blades is located alternately with a blade of the second set of blades, the cutting edge of each blade of the first set of blades being oriented in opposite direction to the orientation of the cutting edge of each blade of the second set of blades, this direction being that of the loading compartment for loading breads into the device. During the operation of the device and more particularly during the slicing of bread, the two supporting frames are moved in opposite directions thanks to a motor 8 as well as a conversion means 9 for converting the movement of this motor into an oscillating movement of each supporting frame of a set of blades.

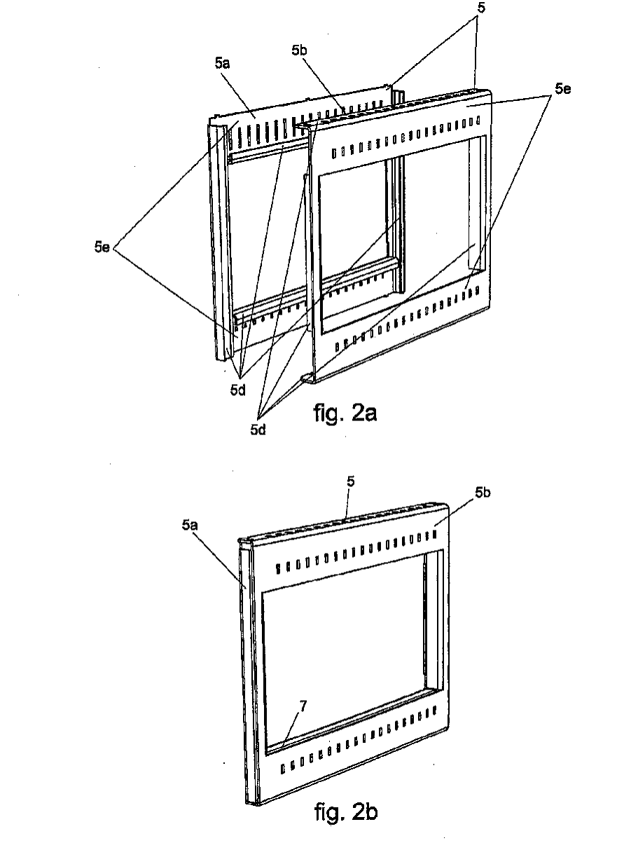

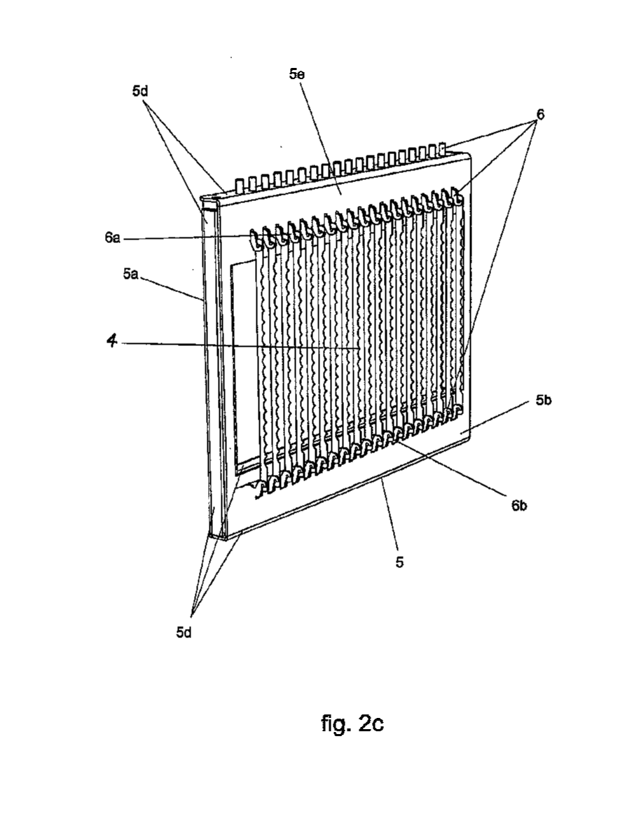

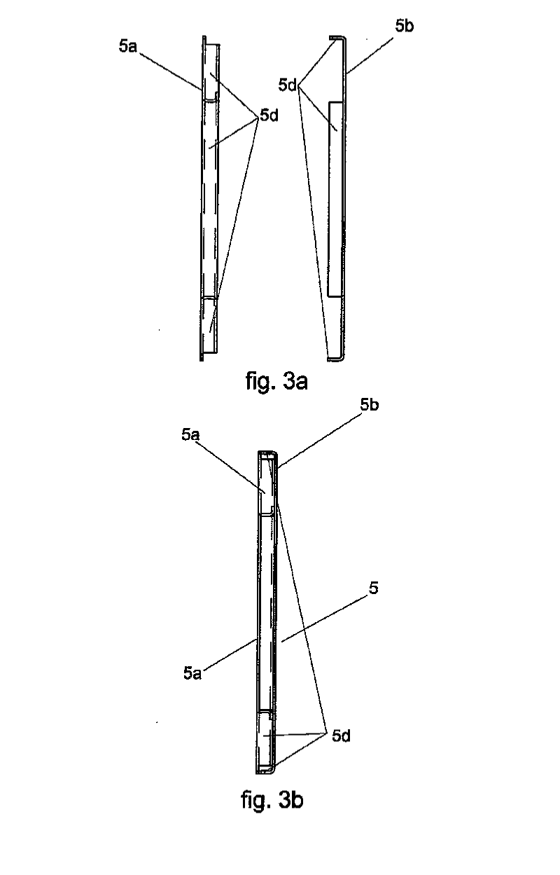

FIGS. 2b and 3b show that each supporting frame has a substantially rectangular shape and comprises two longitudinal members arranged substantially in parallel to each other and two transversal members arranged substantially in parallel to each other and substantially orthogonally to said two longitudinal members and FIG. 2c shows that the blades of a set of blades are connected by each of their extremities to a longitudinal member of a supporting frame by a connecting means 6 and are arranged substantially in parallel to each other and to the transversal members of said frame. As shown in this figure, the connecting means comprises a first 6a and a second 6b set of supporting hooks of an extremity of a blade, each set of hooks being connected to a different longitudinal member of the supporting frame and arranged so that the set of blades is located outside said supporting frame, substantially in parallel to the latter. The first set 6a of hooks is movably connected to a longitudinal member of a frame and each hook of said set of hooks is arranged for being moved substantially in parallel to the transversal members of said frame by a moving means to which said hook is connected in order to control through said moving means the tension applied on the blade which is supported by said hook.

FIGS. 2a to 2c, 3a and 3b show that each frame consists in a first 5a and a second 5b substantially rectangular monolithic rigid elements assembled to each other, in practice face to face, each said rigid element comprising a portion of each longitudinal member and of each transversal member of the frame, each of said portions having a shape which is complementary to the shape of a corresponding portion of the other rigid element of said frame and each of said rigid elements being arranged so that said rigid elements together provide said frame with an hollow tridimensional structure. In practice, each of the two rigid elements comprises one of the two main opposite faces of the frame, one of this face being oriented towards the loading compartment in the device and the other one being oriented towards the discharging compartment in said device. As shown by FIGS. 2b, 2c and 3b, the first and the second rigid element forming a frame are interlocked to each other, each of said rigid elements of said frame comprising a flat portion 5e and portions 5d bended transversally to said flat portion and arranged to lie on the flat portion of the other rigid element of said frame in order to constitute the hollow structure of the frame. FIG. 2b shows that two interlocked rigid elements forming a frame are arranged in order to delimitate between them grooves 7 filled with weld seams for consolidating said rigid elements to each other, each of said grooves being delimitated by one of said bended portion of a rigid element and said flat portion of the other rigid element.

1. Device for the automatic slicing of bread comprising a mount, a loading compartment for loading a bread to be sliced, a discharging compartment for discharging a sliced bread, at least a first set of slicing blades and at least a first supporting frame of said set of slicing blades, arranged between said loading compartment and said discharging compartment, each supporting frame having a substantially rectangular shape and comprising two longitudinal members arranged substantially in parallel to each other and two transversal members arranged substantially in parallel to each other and substantially orthogonally to said two longitudinal members, the blades of a set of blades being connected by each of their extremities to a longitudinal member of a supporting frame by a connecting means and being arranged substantially in parallel to each other and to the transversal members of said frame; wherein each frame consists in a first and in a second substantially rectangular monolithic rigid element assembled to each other, each said rigid element comprising a portion of each longitudinal member and of each transversal member of said frame, each of said portions having a shape which is complementary to the shape of an homolog portion of the other rigid element of said frame and each said rigid element being arranged so that said rigid elements together provide said frame with a tridimensional structure.

2. Device according to claim 1 wherein said tridimensional structure is a hollow structure.

3. Device according to claim 1, wherein said first and said second rigid element forming a frame are assembled by interlocking them to each other.

4. Device according to claim 1, wherein said first and said second rigid elements are interlocked to each other.

5. Device according to claim 1, wherein it comprises two sets of blades and two supporting frames of a set of blades.

6. Device according to claim 1, wherein said connecting means comprises a first and a second set of hooks, each of said hooks being arranged for supporting an extremity of a blade and said sets of hooks being arranged so that said set of blades is located outside of the supporting frame to which said blades are connected by said connecting means and substantially in parallel to said frame.

7. Device according to claim 6, wherein said first set of hooks is movably connected to a longitudinal member of a frame and wherein each hook of said first set of hooks is arranged for being moved substantially in parallel to the transversal members of said frame through a moving means to which said hook is connected in order to control through said moving means the tension in the blade which is supported by said hook.

8. Device according to claim 1, wherein each said rigid elements of said frame comprises a flat portion and portions bended transversally to said flat portion and arranged to lie on the flat portion of the other rigid element of said frame in order to constitute the said tridimensional structure of said frame.

9. Device according to claim 4, wherein said two interlocked rigid elements are arranged in order to delimitate between them grooves filled with weld seams for consolidating said rigid elements to each other.

10. Device according to claim 9, wherein each of said grooves is delimitated by one of said bended portions of a rigid element and said flat portion of the other rigid element.
